(19) United States
(12) Patent Application Publication
(10) Pub. No.: US 2006/0229011 A1
(43) Pub. Date: Oct. 12, 2006

(54) Frequency conversion method using single side band mixer, and frequency conversion circuit using the same

(75) Inventor: Tomohiro Naitou, Oura-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/387,784

(22) Filed: Mar. 24, 2006

(30) Foreign Application Priority Data
Mar. 25, 2005 (JP) 2005-090235
Apr. 26, 2005 (JP) 2005-127782

(51) Int. Cl. H04B 7/24

(52) U.S. Cl. 455/39

(57) ABSTRACT

A frequency conversion circuit is provided, to remove unwanted spurious variations in an output from a single side band mixer. In the frequency conversion circuit, polyphase filters are connected to at least one of input and output ports of a single side band mixer. The polyphase filters associate the spurious variation to be reduced in a square wave signal with an extreme point in its own frequency region. The single side band mixer mixes the signals supplied from the two polyphase filters to produce a frequency component having a frequency difference between both the signals.

### BACKGROUND OF THE INVENTION

1. Field of the Invention

The present invention relates to a frequency conversion method and a frequency conversion circuit for mixing two signals using a single side band mixer to produce a signal at a different frequency, and to a communication system incorporating the same.

2. Description of the Related Art

Communication systems, which employ a frequency conversion circuit, can use a mixer as the frequency conversion circuit (e.g., see Japanese Patent Laid-Open Publication No. 2002-135157). The mixer is capable of using two frequencies F1 and F2 to produce two frequencies (F1±F1) which are different therefrom. In general, either one of the resulting frequencies is an unwanted signal or an image signal, which is thus eliminated using a filter.

Furthermore, a single side band (SSB) mixer (hereinafter referred to as the SSB mixer) can eliminate the image signal without having to use a filter. The SSB mixer includes four mixers, the input terminals of which receive signals with a phase difference of 90 degrees therebetween, respectively. The SSB mixer adds the outputs from each mixer to cancel the image signal.

Suppose that the two frequencies F1 and F2 are used to produce a frequency with a difference therebetween (F1−F2). In this case, when the input signal to the SSB mixer is a sinusoidal wave, the SSB mixer serves to eliminate the image signal at the sum of the frequencies (F1+F2). Accordingly, it is possible to produce only the differential frequency (F1−F1).

However, where the SSB mixer is used such as in a frequency synthesizer, there is often provided a frequency divider upstream of an input terminal of the SSB mixer. In this case, the input signal to the SSB mixer is not a sinusoidal wave but a square wave.

Here, consider a square wave at a certain frequency of ω0. In this case, its Fourier expansion would show that this square wave is represented by a combination of sinusoidal waves at frequencies ω0, 2ω0, 3ω0, 4ω0, 5ω0 and so on. That is, mixing the square waves with each other causes their harmonics to be mixed as well with each other, thereby producing many unwanted tones or spurious variations. To prevent spurious variations from occurring near a desired wave, it is necessary to employ a filter having a high frequency selectivity, thereby causing an increase in circuit layout area. Additionally, forming the aforementioned mixer of a semiconductor integrated circuit would cause an increase in costs of the semiconductor chip.

### SUMMARY OF THE INVENTION

To solve the aforementioned problems, a frequency conversion method according to an aspect of the present invention comprises: pre-reducing a harmonic included in a square wave signal to be supplied to a single side band mixer; and allowing the single side band mixer to mix a plurality of signals including a signal with the harmonic reduced. The harmonics to be reduced may be the third-order harmonic or the third-order and fifth-order harmonics.

According to this aspect, a harmonic component is pre-reduced from a square wave signal to be supplied to the single side band mixer, thereby making it possible to efficiently reduce a spurious variation which will occur in an output signal from the single side band mixer.

Another aspect of the present invention is to provide a frequency conversion circuit. This frequency conversion circuit comprises a single side band mixer; and a polyphase filter connected at least to one of input and output ports of the single side band mixer. The polyphase filter associates an extreme point in its own frequency region with the spurious variation to be reduced in the supplied square wave signal. The “extreme point” may also be adjusted to an integral multiple of the frequency of the supplied square wave signal.

According to this aspect, it is possible to efficiently reduce spurious variations included in an output signal from the single side band mixer. Furthermore, since the polyphase filter is used, it is possible to reduce spurious variations while preventing an increase in circuit layout area.

Another aspect of the present invention is also to provide a frequency conversion circuit. This frequency conversion circuit comprises a single side band mixer; and a polyphase filter connected upstream of the single side band mixer. The polyphase filter associates an extreme point in its own frequency region with a spurious variation to be reduced in the supplied square wave signal.

According to this aspect, it is possible to efficiently reduce spurious variations included in an output signal from the single side band mixer. Furthermore, since the polyphase filter is used, it is possible to reduce spurious variations while preventing an increase in circuit layout area.

The polyphase filter may associate the extreme point with the third-order harmonic included in the supplied square wave signal. On the other hand, the polyphase filter may be formed of a plurality of stages so as to include a stage associating the extreme point at least with the third-order harmonic and a stage associating the extreme point with the fifth-order harmonic.

At least one of the polyphase filters may include a variable element so that the extreme point can be controlled. This makes it possible to dynamically reduce spurious variations in the event of a change occurring in a signal supplied to the polyphase filter.

The extreme point in the frequency region may include a dip frequency in a negative frequency region. Associating the dip frequency with a spurious variation to be reduced will provide a significant effect on the reduction of the spurious variation.

Another aspect of the present invention is to provide a communication system. This communication system comprises: an oscillator unit which oscillates a square wave local signal; and a frequency conversion circuit which mixes the oscillated local signal and an externally received signal to produce a signal at a predetermined frequency. According to this aspect, it is possible construct a communication system which satisfies the requirements for both characteristics and circuit scales at the same time.

It is to be understood that any combination of the aforementioned components or the representations of the present invention exchanged into methods, apparatuses, or systems are also included in an aspect of the present invention.

### BRIEF DESCRIPTION OF THE DRAWINGS

FIG. 1 is a view showing an exemplary configuration of a frequency conversion circuit according to a first embodiment of the present invention;

FIG. 2 is a view showing an exemplary configuration of the polyphase filter according to the first embodiment of the present invention;

FIG. 3 is a view showing the characteristics having a combination of the positive and negative frequency characteristics of the polyphase filter according to the first embodiment of the present invention;

FIG. 4 is a view showing exemplary transitional frequency spectra in the frequency conversion circuit shown in FIG. 1;

FIG. 5 is a view showing an exemplary configuration of a frequency conversion circuit to be compared with the frequency conversion circuit according to the first embodiment of the present invention;

FIG. 6 is a view showing exemplary transitional frequency spectra in the frequency conversion circuit shown in FIG. 5;

FIG. 7 is a view showing the frequency conversion circuit according to the first embodiment of the present invention;

FIG. 8 is a view showing a modified example of the frequency conversion circuit of FIG. 7;

FIG. 9 is a view showing a communication system incorporating the frequency conversion circuit according to the first embodiment of the present invention;

FIG. 10 is a view showing the configuration of a sinusoidal wave generation circuit according to a second embodiment of the present invention;

FIG. 11 is a view showing an exemplary configuration of a polyphase filter according to the second embodiment of the present invention;

FIG. 12 is a view showing the characteristics having a combination of the positive and negative frequency characteristics of the polyphase filter according to the second embodiment of the present invention;

FIG. 13A is a view showing the phasor diagram of a square wave I+ delivered from the square wave output circuit according to the second embodiment of the present invention;

FIG. 13B is a view showing the phasor diagram of a square wave Q+ delivered from the square wave output circuit according to the second embodiment of the present invention;

FIG. 13C is a view showing the phasor diagram of a square wave I− delivered from the square wave output circuit according to the second embodiment of the present invention;

FIG. 13D is a view showing the phasor diagram of a square wave Q− delivered from the square wave output circuit according to the second embodiment of the present invention;

FIG. 14 is a view showing the configuration of a sinusoidal wave generation circuit according to a first modified example of the second embodiment of the present invention;

FIG. 15 is a view showing the configuration of a frequency conversion circuit according to a second modified example of the second embodiment of the present invention;

FIG. 16 is a view showing the configuration of a frequency synthesizer according to a third modified example of the second embodiment of the present invention; and

FIG. 17 is a view showing a communication system according to a fourth modified example of the second embodiment of the present invention.

### DETAILED DESCRIPTION OF THE INVENTION

In the description of the preferred embodiments of the present invention with reference to the accompanying drawings, specific terms are used only for clarity of the invention. However, it is to be understood that the present invention is not to be limited to those specific items used herein, but cover all the equivalent techniques that are practiced in a like manner to achieve like objects.

### First Embodiment

Briefing this embodiment, a frequency conversion circuit according to the present invention is configured to have a polyphase filter (PPF) connected to at least one of three input/output ports (RF, LO, and IF) that are included in a SSB mixer. This SSB mixer is supplied with and mixes two square waves to produce signals at frequencies different therefrom.

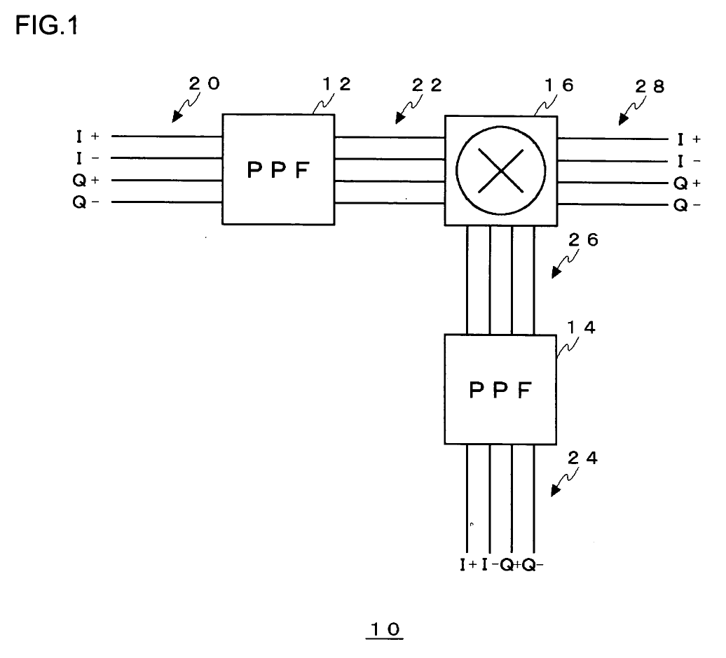

FIG. 1 is a view showing the configuration of the frequency conversion circuit according to the first embodiment of the present invention. In the frequency conversion circuit 10, the square wave at a frequency of F1 is supplied to a first polyphase filter 12. The square wave at a frequency of F2 is supplied to a second polyphase filter 14. The first polyphase filter 12 and the second polyphase filter 14 each include four input terminals, to which respectively supplied are signals that are phase shifted by 90 degrees relative to each other. The first polyphase filter 12 and the second polyphase filter 14 eliminate or attenuate the frequency component corresponding to the extreme point of their frequency characteristics and then output a sinusoidal wave signal to a SSB mixer 16. The first polyphase filter 12 and the second polyphase filter 14 will be explained below in more detail.

As described above, the SSB mixer 16 includes four mixers. The SSB mixer includes two input ports, each having four input terminals. The four terminals of one of the input ports are supplied from the first polyphase filter 12 with signals that are phase shifted by 90 degrees relative to each other. The four terminals of the other input port are supplied from the second polyphase filter 14 with signals that are phase shifted by 90 degrees relative to each other.

The SSB mixer 16 provides a product of the signal from the first polyphase filter 12 and the signal from the second polyphase filter 14 to produce the differential frequency between the signals or a desired wave. In the case of the SSB mixer 16, such a signal having the sum of the frequencies of both the signals is canceled out.

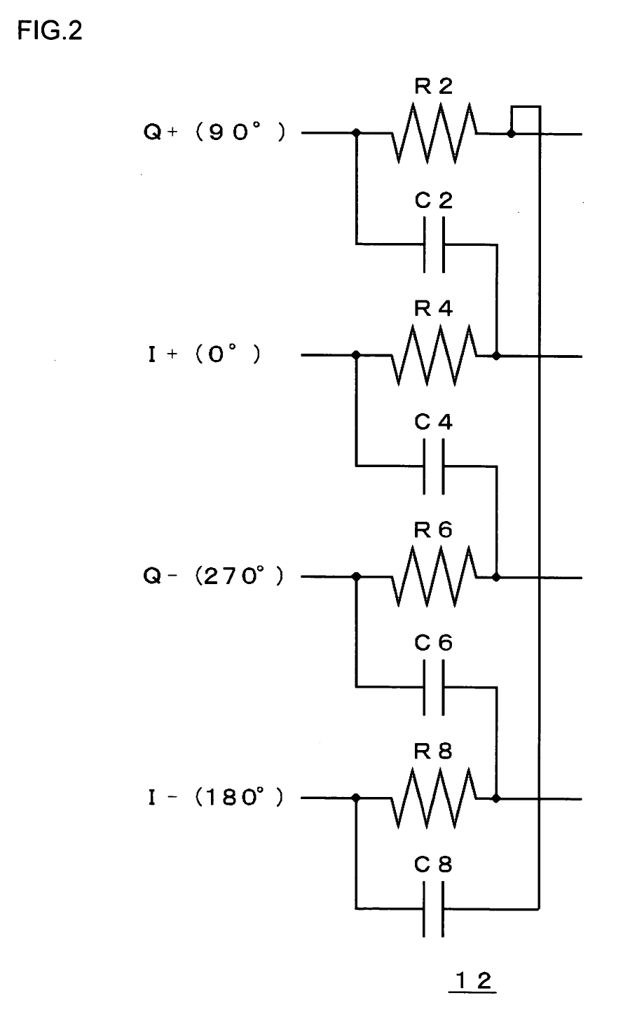

FIG. 2 is a view showing an exemplary configuration of the polyphase filter according to the first embodiment of the present invention. The first polyphase filter 12 includes four input terminals and four output terminals, wherein four paths for connecting therebetween are provided with resistors R2, R4, R6, and R8, respectively. The input side of the first resistor R2 on the first path and the output side of the second resistor R4 on the second path are connected together with a first capacitor C2 disposed in series on the path therebetween. Furthermore, the output side of the first resistor R2 on the first path and the input side of the fourth resistor R8 on the fourth path are connected together with a fourth capacitor C8 disposed in series on the path therebetween. Likewise, the input side of the second resistor R4 on the second path and the output side of the third resistor R6 on the third path are connected together with a second capacitor C4 disposed in series on the path therebetween. Additionally, the input side of the third resistor R6 on the third path and the output side of the fourth resistor R8 on the fourth path are connected together with a third capacitor C6 disposed in series on the path therebetween.

To operate the first polyphase filter 12 with this configuration in the positive frequency region, the sinusoidal wave I+ having a reference phase is supplied to the input terminal of the first path; the sinusoidal wave Q+ leading the reference phase by 90 degrees is supplied to the input terminal of the second path; the sinusoidal wave I− leading the reference phase by 180 degrees is supplied to the input terminal of the third path; and the sinusoidal wave Q− leading the reference phase by 270 degrees is supplied to the input terminal of the second path.

In contrast to this, to operate the first polyphase filter 12 in the negative frequency region, the sinusoidal wave I+ having a reference phase is supplied to the input terminal of the second path; the sinusoidal wave Q+ leading the reference phase by 90 degrees is supplied to the input terminal of the first path; the sinusoidal wave I− leading the reference phase by 180 degrees is supplied to the input terminal of the fourth path; and the sinusoidal wave Q− leading the reference phase by 270 degrees is supplied to the input terminal of the third path.

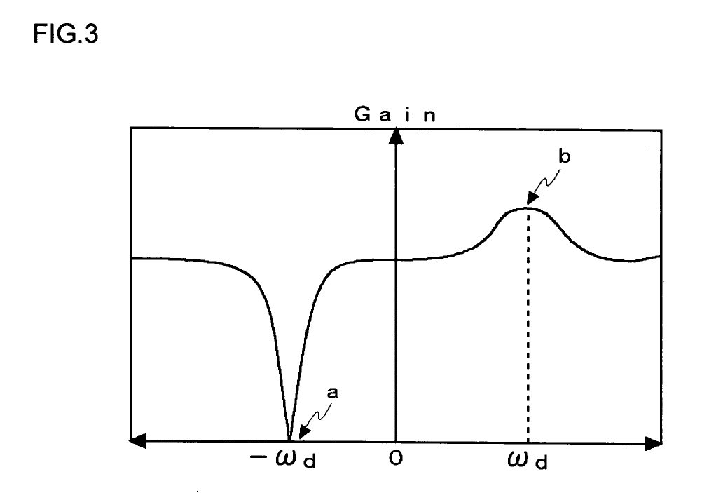

FIG. 3 is a view showing the characteristics having a combination of the positive and negative frequency characteristics of the polyphase filter according to the first embodiment of the present invention. As shown in FIG. 3, the polyphase filter has extreme points a and b in both the positive and negative frequency regions. In particular, the negative frequency region has the extreme point a that accompanies a large attenuation or a dip frequency.

In this embodiment, the first polyphase filter 12 and the second polyphase filter 14 adjust the dip frequency to an integral multiple of the frequency of the input signal. That is, the polyphase filters 12 and 14 can eliminate harmonics, or particularly the third-order harmonic, included in the supplied square wave, and thus make it possible to efficiently reduce spurious variations included in the output signal from the SSB mixer 16.

Here, an explanation will now be given to the reason why the third-order harmonic of the harmonics included in the square wave should be eliminated. By way of example, consider a square wave having a duty ratio of 50%. This is an odd function, which thus includes only harmonics of odd-order components. Its Fourier expansion is given by the following equation:
E=sin ω0−⅓ sin 3ω0+⅕ sin 5ω0− 1/7 sin 7ω0+ . . .

Among the harmonics, the third-order harmonic has the largest amplitude. The amplitude decreases with increasing orders as the fifth-order, the seventh order and so on. Furthermore, the third-order harmonic has the frequency that is closest to the fundamental wave component, and thus causes a spurious variation to occur in the closest proximity to the desired wave. That is, the third-order harmonic has the most significant effect, and adverse effects tend to less likely happen with increasing orders as the fifth-order, the seventh order and so on. Accordingly, it can be said that eliminating the third-order harmonic provides a significant reduction in spurious variations.

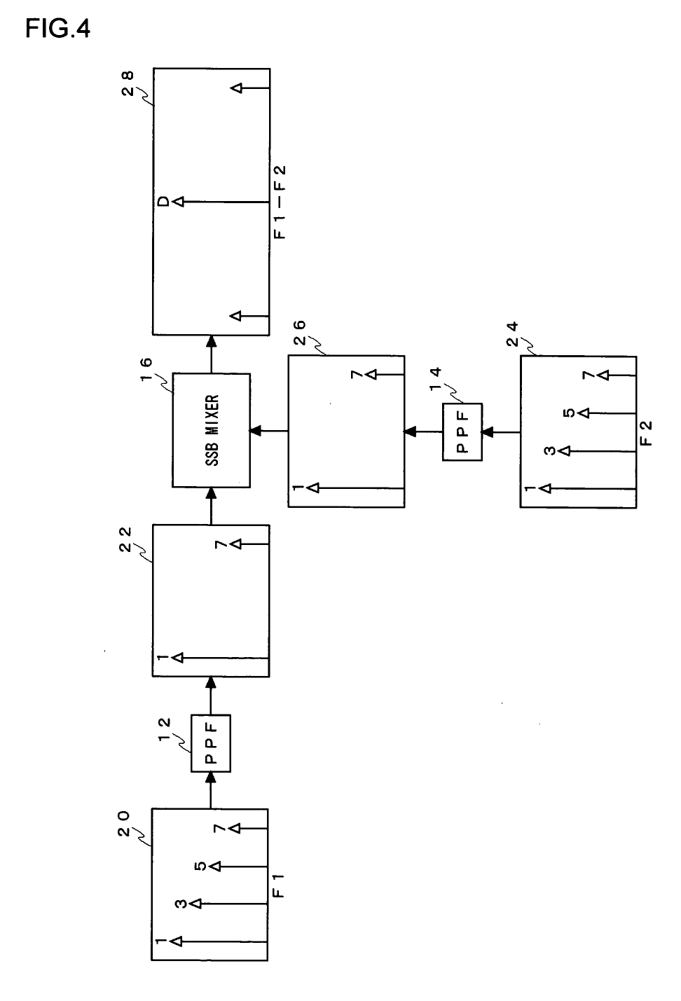

FIG. 4 is a view showing exemplary transitional frequency spectra in the frequency conversion circuit shown in FIG. 1. A frequency spectrum 20 of the square wave supplied to the first polyphase filter 12 includes the fundamental wave and the third-order, fifth-order, and seventh-order harmonics. In FIG. 4, the first polyphase filter 12 eliminates the third-order and fifth-order harmonics. Accordingly, a frequency spectrum 22 of the output signal from the first polyphase filter 12 includes mainly the fundamental wave and the seventh-order harmonic. Likewise, a frequency spectrum 24 of a square wave supplied to the second polyphase filter 14 also includes the fundamental wave and the third-order, fifth-order, and seventh-order harmonics, while a frequency spectrum 26 of the output signal from the second polyphase filter 14 includes mainly the fundamental wave and the seventh-order harmonic.

The SSB mixer 16 mixes the input signals from the first polyphase filter 12 and the second polyphase filter 14 to produce a desired wave D. A frequency spectrum 28 of the output signal from the SSB mixer 16 exhibits the desired wave D with spurious variations suppressed. That is, no spurious variations will occur in the vicinity of the desired wave D but only low-power spurious variations will occur in a frequency region away from the desired wave D.

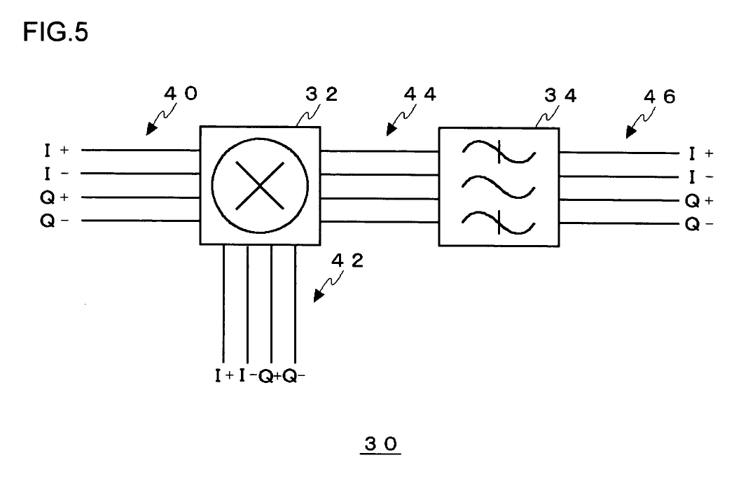

FIG. 5 is a view showing an exemplary configuration of a frequency conversion circuit to be compared with the frequency conversion circuit according to the first embodiment of the present invention. This frequency conversion circuit 30 for comparison is configured such that no polyphase filter is connected to the input and output terminals of a SSB mixer 32. The output side of the SSB mixer 32 is connected with a high-order bandpass filter (BPF) 34. The output side may also be connected with an LC resonator instead of a bandpass filter.

The SSB mixer 32 has two input ports, which are each provided with four input terminals. The four terminals on one input port are supplied with square waves at a frequency of F1 which are phase shifted by 90 degrees relative to each other. The four terminals on the other input port are supplied with square waves at a frequency of F2 which are phase shifted by 90 degrees relative to each other.

The SSB mixer 32 mixes the square wave at a frequency of F1 and the square wave at a frequency of F2, which are supplied from different input ports, to produce a desired wave. The SSB mixer 32 then outputs the signals that are phase shifted by 90 degrees relative to each other to the high-order bandpass filter 34. The high-order bandpass filter 34 allows those frequency components within a predetermined range including the desired wave to pass therethrough but the other frequency components to be attenuated.

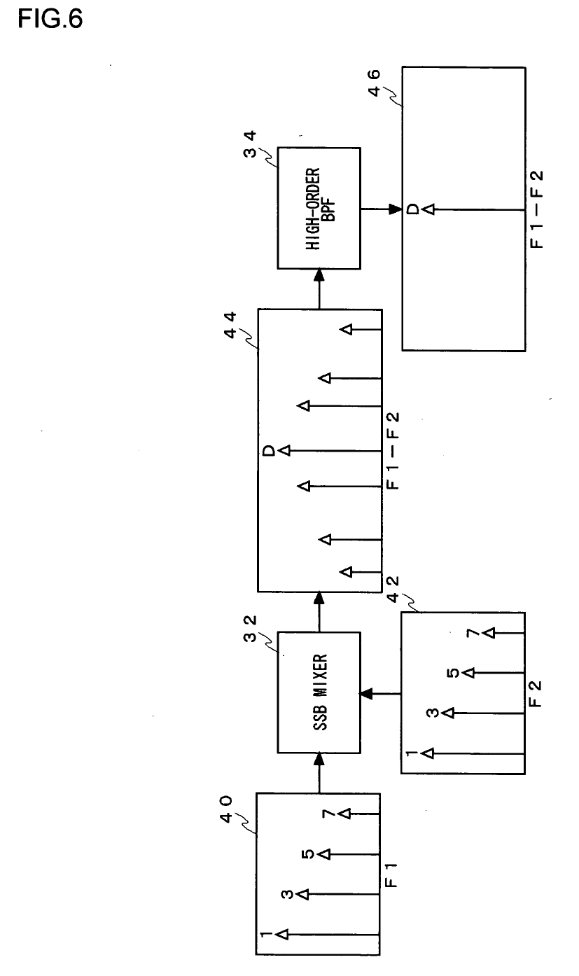

FIG. 6 is a view showing exemplary transitional frequency spectra in the frequency conversion circuit 30 shown in FIG. 5. Two square wave frequency spectra 40 and 42 supplied to the SSB mixer 32 include the fundamental wave, and the third-order, fifth-order, and seventh-order harmonics. A frequency spectrum 44 of the output signal from the SSB mixer 32 has spurious variations occurring in the vicinity of the desired wave D. For example, the frequency component of the sum of the aforementioned frequency F1 and the third-order harmonic of the frequency F2 or conversely the frequency component of the sum of the third-order harmonic of the frequency F1 and the frequency F2 or the like occurs as spurious variations having a significant effect. A frequency spectrum 46 of the output signal from the high-order bandpass filter 34 exhibits the desired wave D with spurious variations suppressed. That is, frequency components forming spurious variations in the vicinity of the desired wave D are filtered through the high-order bandpass filter 34.

A comparison between the frequency conversion circuit 10 of FIG. 1 according to this embodiment and the frequency conversion circuit 30 of FIG. 5 shows that both the circuits can reduce spurious variations in a like manner; however, the former can realize it with a much more reduced circuit layout area. That is, use of a steep filter such as a high-order bandpass filter or an LC resonator would cause an increase in circuit layout area. In this regard, the polyphase filter requires a far less circuit layout area when compared with the high-order bandpass filter or the LC resonator. Depending on the application, the circuit layout area can be reduced to 1/10 or less.

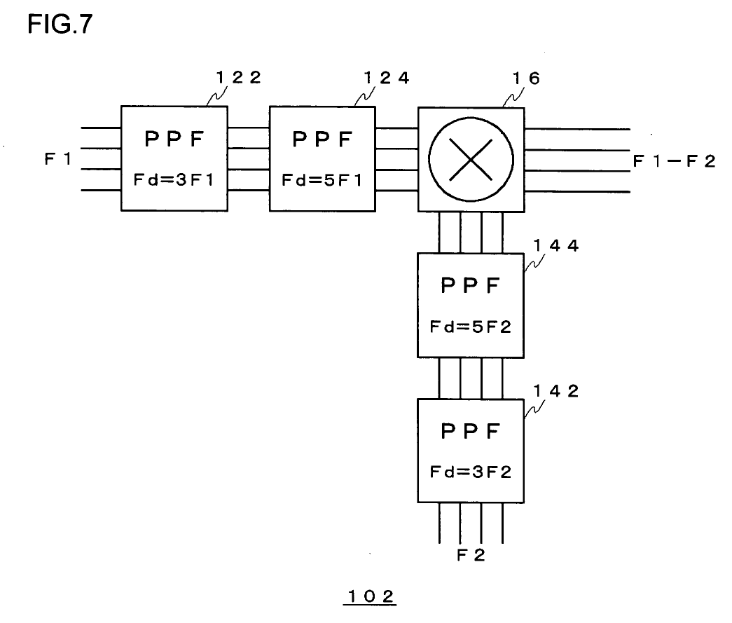

Now, an explanation will be given to an implementation example of the frequency conversion circuit 10 according to this embodiment. FIG. 7 is a view showing the frequency conversion circuit according to the first embodiment of the present invention. In the frequency conversion circuit 102 according to this embodiment, the two input ports of the SSB mixer 16 are each connected with polyphase filters in two stages. An extreme point of the frequency characteristic of the first-stage polyphase filters 122 and 142 is adjusted to the frequency of the third-order harmonic of and input signal. An extreme point of the frequency characteristic of the second-stage polyphase filters 124 and 144, e.g., a dip frequency, is adjusted to the frequency of the fifth-order harmonic of the input signal. The frequency conversion circuit 102 according to this embodiment reduces the third-order and fifth-order harmonics included in a supplied square wave and thereafter supplies the resulting signal to the SSB mixer 16, thereby making it possible to efficiently suppress unwanted spurious variations. Furthermore, the use of the polyphase filter will not require a significant increase in circuit scale.

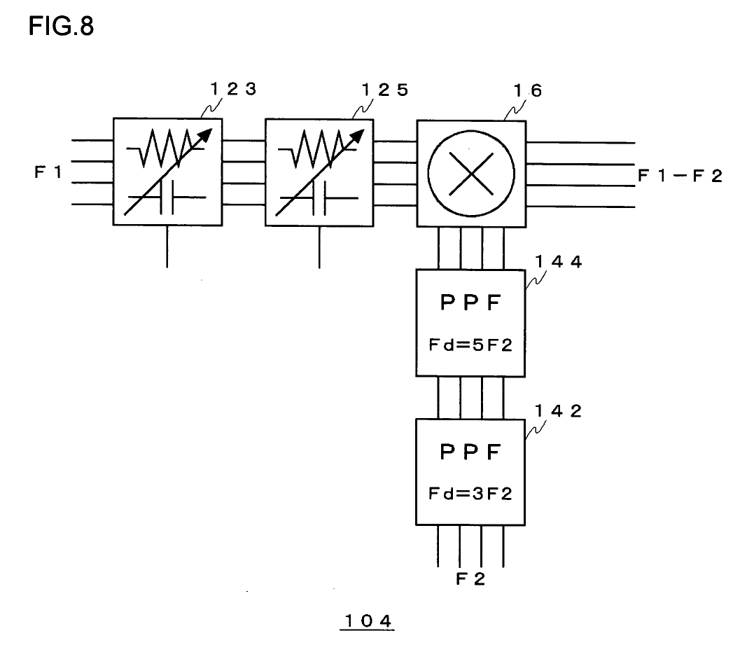

FIG. 8 is a view showing a modified example of the frequency conversion circuit of FIG. 7. The configuration of the frequency conversion circuit 104 according to this modified example is basically the same as that of the embodiment shown in FIG. 7. The difference lies in that the first-stage polyphase filter 122 and the second-stage polyphase filter 124 according to the implementation example of FIG. 7 are formed of variable elements. That is, the first-stage polyphase filter 123 and the second-stage polyphase filter 125 according to this modified example are composed of variable elements such as variable resistor or variable capacitors. Even in the presence of a change in frequency of an input signal, the frequency conversion circuit 104 according to this modified example allows external control to be provided to the value of the variable elements of at least one of the first-stage polyphase filter 122 and the second-stage polyphase filter 124. This makes it possible to easily set the extreme point of the frequency characteristic of each of the polyphase filters 123 and 125 to an integral multiple of the frequency of the aforementioned input signal.

In this manner, the frequency conversion circuit 104 according to this modified example reduces harmonics included in a supplied square wave and thereafter supplies the resulting signal to the SSB mixer 16, thereby making it possible to efficiently and dynamically suppress unwanted spurious variations. Furthermore, the use of the polyphase filter will not require a significant increase in circuit scale.

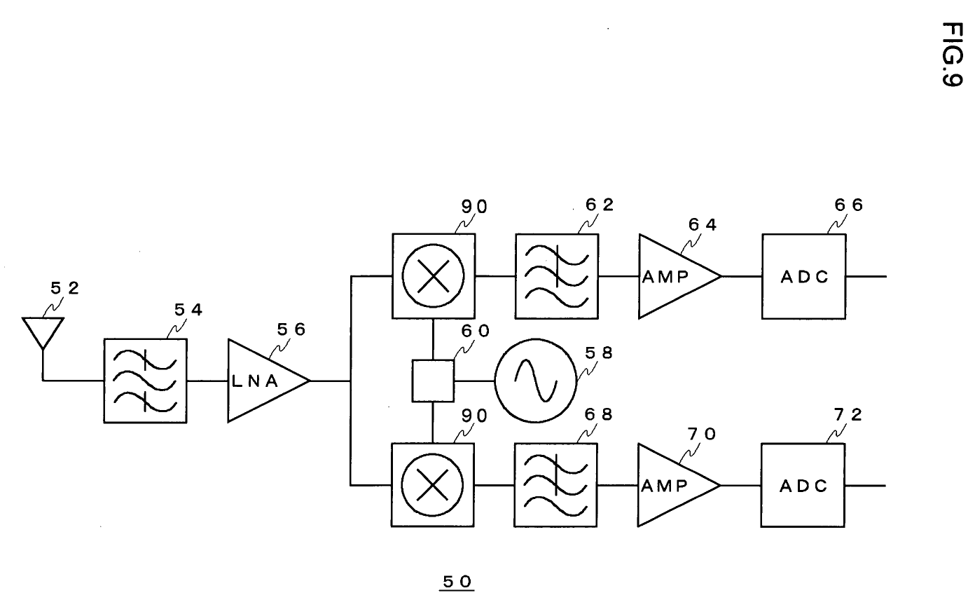

FIG. 9 is a view showing a communication system incorporating the frequency conversion circuit according to the first embodiment of the present invention. A communication system 50 shown in FIG. 9 can employ, but is not limited to, the direct conversion receive (DCR) scheme, and as well other reception schemes such as the heterodyne reception scheme.

In FIG. 9, an RF signal received from an antenna 52 is supplied to a LNA (Low Noise Amplifier) 56 via a bandpass filter 54. The LNA 56 amplifies the RF signal with reduced noise and outputs the resulting signal to two frequency conversion circuits 90 for use with the quadrature baseband signals or the I signal and Q signal. A local oscillator 58 may also be applied to these frequency conversion circuits 90.

The local oscillator 58 outputs a local signal at a local (Lo) frequency. A phasor 60 outputs the Lo signal with its phase unchanged to the I-based frequency conversion circuit 90, while also delivering, to the Q-based frequency conversion circuit 90, the Lo signal having a phase leading by 90 degrees with respect to the Lo signal delivered to the I-based frequency conversion circuit 90. The signals delivered to these circuits have a square wave shape.

The I-based and the Q-based frequency conversion circuits 90 mix the RF signal and the Lo signal, and then output a signal having a frequency difference therebetween to each of low pass filters 62 and 68. An output signal from each of the low pass filters 62 and 68 is amplified through respective amplifiers 64 and 70 and then converted into a digital signal by respective analog to digital converters 66 and 72.

In this manner, by the use of the local oscillator 58 including the frequency conversion circuits 90 of this embodiment for the communication system 50, it is possible to provide both improved characteristics and a reduction in circuit scale at the same time to communication systems. In particular, all or part of the circuit components described as the communication system 50 can be incorporated into a semiconductor chip as a frequency synthesizer, thereby allowing the chip area to be reduced.

The present invention has been described in accordance with the embodiment. It is to be understood by those skilled in the art that while the embodiment is only illustrative, a variety of modifications can be made to the combination of each of the components and processes thereof and those modified examples also fall within the scope of the present invention.

As described above, the embodiment is configured to provide the polyphase filters 122 and 124 for both the two input signals having different frequencies to the SSB mixer 16. In this regard, it is also acceptable to provide only one of the polyphase filters. This also provides a certain level of reduction in spurious variation.

Furthermore, a polyphase filter may also be provided on the output side of the SSB mixer 16. In this case, it is possible to reduce spurious variations by associating an extreme point in the frequency region of the polyphase filter with the frequency region of the spurious variation to be reduced which occurs in the output signal from the SSB mixer 16.

Furthermore, the implementation example shown in FIG. 7 provides two-stage polyphase filters in order to reduce the third-order and fifth-order harmonics. In this regard, it is also possible to provide one stage in order to reduce only the third-order harmonic, or, three stages or more in order to reduce the seventh-order harmonic and the subsequent frequency components as well. This makes it possible to reduce spurious variations with further improved accuracy.

Additionally, in accordance with the modified example shown in FIG. 8, a polyphase filter including variable elements was described. In this regard, one or more of the plurality of polyphase filters forming the frequency conversion circuit may also be configured to include variable elements. This makes it possible to use members with efficiency.

### Second Embodiment

This embodiment relates to a signal generation circuit for generating sinusoidal waves, and a frequency conversion circuit, a frequency synthesizer, and a communication system which incorporate the same.

Communication systems, which employ a frequency conversion circuit, can use a mixer as the frequency conversion circuit (e.g., Japanese Patent Laid-Open Publication No. 2002-135157). When a signal including an unwanted tone or a spurious variation is supplied to such a frequency conversion circuit like a mixer, a spurious variation will also occur in the output signal.

For example, to use a mixer in a frequency synthesizer, a frequency divider is often connected upstream of the input terminals of the mixer. In this case, an input signal to the mixer is a square wave. Here, consider a square wave at a frequency of ω0. Its Fourier expansion shows that this square wave is expressed by a combination of sinusoidal waves of frequencies ω0, 2ω0, 3ω0, 4ω0, 5ω0 and so on. That is, mixing square waves with each other would also mix their harmonics with each other, causing many spurious variations to occur. In order to avoid this situation, the signal to be supplied to the mixer should desirably have a sinusoidal wave shape.

Conventionally, to obtain a generally perfect sinusoidal wave from a signal or a square wave including a spurious variation, filters have been used such as a Low Pass Filter (LPF), High Pass Filter (HPF), Band Pass Filter (BPF), or Band Rejection Filter (BRF). However, in this case, a high-order BPF having a high frequency selectivity or an LC resonator is required. These circuits in turn require a large area, and would thus cause an increase in costs for the semiconductor chip.

An aspect of this embodiment relates to a signal generation circuit. The signal generation circuit comprises: a square wave output circuit which outputs a square wave signal; and one or more stages of polyphase filters which receive a signal delivered from the square wave output circuit and which associate an extreme point in an own frequency region with an Nth harmonic (wherein N is an odd number equal to three or more) included in the input signal.

According to this aspect, the polyphase filter can eliminate harmonics of the square wave signal which may cause spurious variations. Accordingly, it is possible to obtain a sinusoidal wave with its spurious variations eliminated or reduced using the square wave output circuit that can be configured with a simple circuit and a polyphase filter that requires only a small circuit layout area.

In this aspect, at least one of the one or more stages of polyphase filters may associate an extreme point in its own frequency region with the third-order harmonic included in the input signal. This makes it possible to employ only a small circuit layout area to eliminate or reduce the third-order harmonic which may cause a spurious variation in the closest proximity to the desired wave.

In this aspect, at least one of the one or more stages of polyphase filters may include a variable element so as be able to control the “extreme point.” Even in the presence of a change in the frequency of a square wave input signal, this allows for providing control to the variable elements, thereby associating the “extreme point” of the polyphase filter all the time with the third-order harmonic of the input signal.

Another aspect of this embodiment relates to a frequency conversion circuit. This circuit comprises: a mixer having input ports; and a signal generation circuit according to the present invention that is connected to at least one of the input ports of the mixer. According to this aspect, since a signal with unwanted spurious variations removed is supplied to the mixer, it is possible to obtain a frequency converted signal that is free from spurious variations. Furthermore, the use of the polyphase filter will not require a significant increase in circuit scale. Accordingly, it is possible to provide both improved characteristics and a reduction in circuit scale at the same time to the frequency conversion circuit.

Another aspect of this embodiment relates to a frequency synthesizer. This frequency synthesizer includes a plurality of frequency conversion circuits which are connected in parallel or cascade. The frequency synthesizer is characterized in that at least a frequency conversion circuit located at the last stage out of the circuits is a frequency conversion circuit according to the present invention. According to this aspect, since at least the frequency conversion circuit located at the last stage is a frequency conversion circuit using a polyphase filter, it is possible to obtain a sinusoidal wave having a desired frequency with unwanted spurious variations suppressed as output from the frequency synthesizer, with a small-scale circuit layout area. Accordingly, it is possible to realize both improved characteristics and a reduction in circuit scale at the same time.

Another aspect of this embodiment relates to a communication system. This communication system comprises: an oscillator unit which oscillates a local signal; and a frequency conversion circuit which mixes the oscillated local signal and an externally received signal to produce a signal at a predetermined frequency, wherein the oscillator unit is formed of a frequency synthesizer according to the present invention. According to this aspect, it is possible construct a communication system which satisfies the requirements both for characteristics and circuit scales at the same time.

It is to be understood that any combination of the aforementioned components or the representations of the present invention exchanged between methods, apparatuses, or systems are also included in the aspects of the present invention.

According to the present invention, it is possible to employ only a small circuit layout area in order to obtain a sinusoidal wave signal with spurious variations reduced.

Now, an explanation will be given to this embodiment.

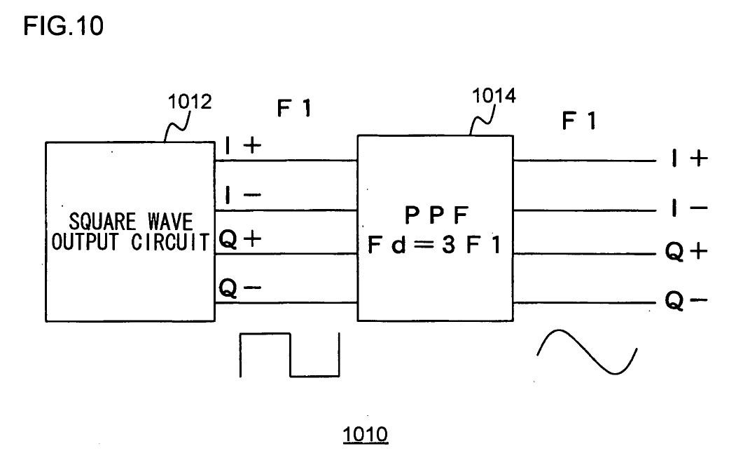

FIG. 10 is a view showing the configuration of a sinusoidal wave generation circuit 1010 according to the second embodiment of the present invention. The sinusoidal wave generation circuit 1010 includes a square wave output circuit 1012 and a polyphase filter (PPF) 1014.

The square wave output circuit 1012 outputs multi-phase square waves. That is, the square wave output circuit 1012 outputs four square waves I+, I−, Q+, and Q−, all of which have the same frequency F1 and are phase shifted by 90 degrees relative to each other. With I+ employed as a reference phase, Q+ leads the reference phase by 90 degrees, I− leads the reference phase by 180 degrees, and Q− leads the reference phase by 270 degrees. The square wave output circuit 1012 that outputs such a square wave can be implemented with a Phase Locked Loop (PLL) circuit, a ring Voltage Controlled Oscillator (VCO), or a ring oscillator. On the other hand, it is also acceptable to use a frequency divider as the square wave output circuit 1012. In this case, the square wave output circuit 1012 has an input terminal for receiving a square wave signal.

The four square waves I+, I−, Q+, and Q− delivered from the square wave output circuit 1012 are supplied to the polyphase filter 1014. As detailed later, when operated with the negative frequency characteristic, the polyphase filter 1014 eliminates or attenuates the frequency component corresponding to the extreme point of its frequency characteristic, and has four input terminals and four output terminals, with four paths connecting therebetween. Thus, the square wave I+ is supplied to the input terminal of the first path, the square wave Q+ to the input terminal of the second path, the square wave I− to the input terminal of the third path, and the square wave Q− to the input terminal of the fourth path. Furthermore, the polyphase filter 1014 according to the second embodiment allows an extreme point Fd of its frequency characteristic to be adjusted to be at three times the frequency F1 of the square wave delivered from the square wave output circuit 1012.

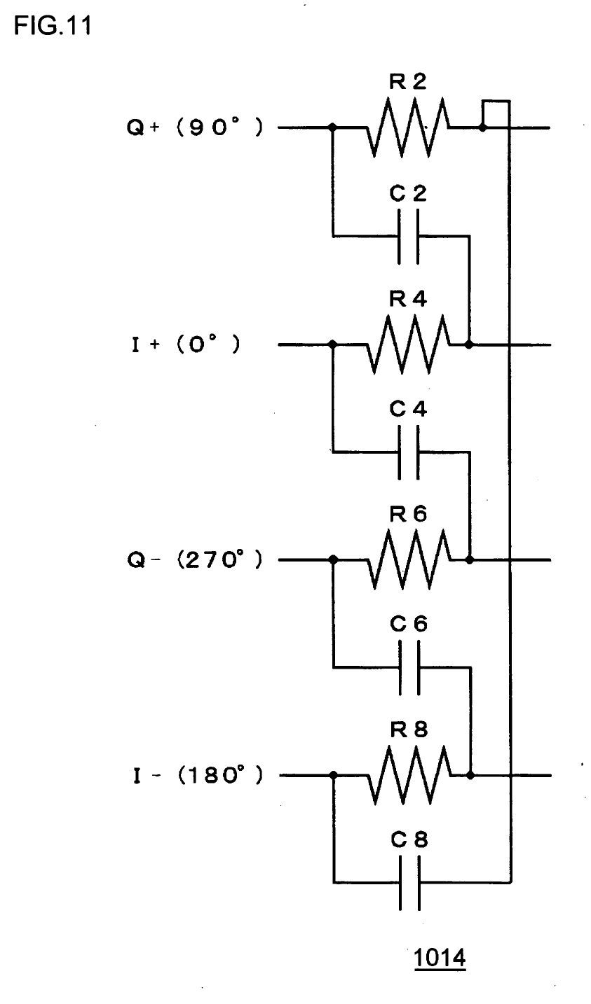

Now, a detailed explanation will be given to the polyphase filter. FIG. 11 is a view showing an exemplary configuration of the polyphase filter according to the second embodiment of the present invention. As mentioned above, the polyphase filter 1014 includes four input terminals and four output terminals, wherein the four paths for connecting therebetween are provided with resistors R2, R4, R6, and R8, respectively. The input side of the first resistor R2 on the first path and the output side of the second resistor R4 on the second path are connected together with a first capacitor C2 disposed in series on the path therebetween. Furthermore, the output side of the first resistor R2 on the first path and the input side of the fourth resistor R8 on the fourth path are connected together with a fourth capacitor C8 disposed in series on the path therebetween. Likewise, the input side of the second resistor R4 on the second path and the output side of the third resistor R6 on the third path are connected together with a second capacitor C4 disposed in series on the path therebetween. Additionally, the input side of the third resistor R6 on the third path and the output side of the fourth resistor R8 on the fourth path are connected together with a third capacitor C6 disposed in series on the path therebetween. The four resistors R2, R4, R6, and R8 have the same resistance R, while the four capacitors C2, C4, C6, and C8 have the same capacitance C.

In this configuration, when a sinusoidal wave having a reference phase is supplied to the input terminal of the first path, a sinusoidal wave leading the reference phase by 90 degrees is supplied to the input terminal of the second path, a sinusoidal wave leading the reference phase by 180 degrees is supplied to the input terminal of the third path, and a sinusoidal wave leading the reference phase by 270 degrees is supplied to the input terminal of the fourth path, the polyphase filter 1014 will operate in the positive frequency region.

In contrast to this, when a sinusoidal wave having a reference phase is supplied to the input terminal of the second path, a sinusoidal wave leading the reference phase by 90 degrees is supplied to the input terminal of the first path, a sinusoidal wave leading the reference phase by 180 degrees is supplied to the input terminal of the fourth path, and a sinusoidal wave leading the reference phase by 270 degrees is supplied to the input terminal of the third path, the polyphase filter 1014 will operate in the negative frequency region.

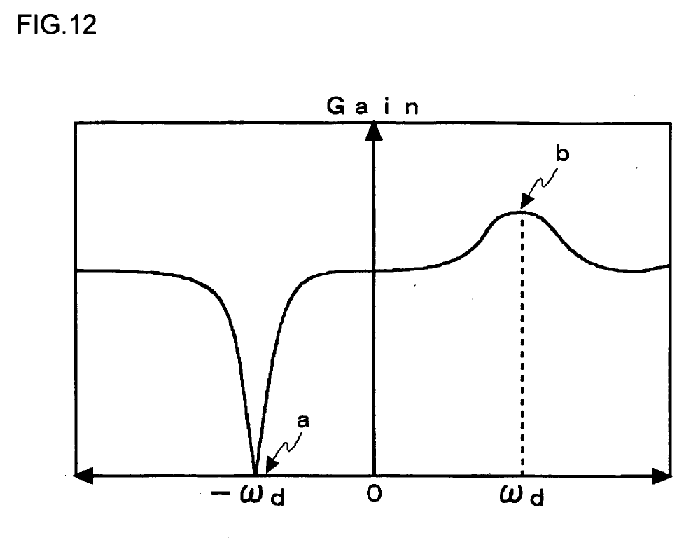

FIG. 12 is a view showing the characteristics having a combination of the positive and negative frequency characteristics of the polyphase filter according to the second embodiment of the present invention. As shown in FIG. 12, the polyphase filter has extreme points a and b in both the positive and negative frequency regions. In particular, the negative frequency region has the extreme point a that accompanies a large attenuation or a dip frequency. In the polyphase filter of FIG. 11, this dip frequency is expressed by 1/(2πRC).

In this embodiment, as described above, the dip frequency of the polyphase filter 1014 is adjusted to be three times the frequency the input square wave. That is, the polyphase filter 1014 can eliminate harmonics included in the supplied square wave, particularly, the third-order harmonic.

Here, an explanation will now be given to the reason why the third-order harmonic of the harmonics included in the square wave should be eliminated. By way of example, consider a square wave having a duty ratio of 50%. This is an odd function, which thus includes only odd-order component harmonics. Its Fourier expansion is given by the following equation:
E=sin ω0−⅓ sin 3ω0+⅕ sin 5ω0− 1/7 sin 7ω0+ . . .

Among the harmonics, the third-order harmonic has the largest amplitude. The amplitude decreases with increasing orders as the fifth-order, the seventh order and so on. Furthermore, the third-order harmonic has the frequency that is closest to the fundamental wave component, and thus causes a spurious variation to occur in the closest proximity to the desired wave. That is, the third-order harmonic has the most significant effect, and adverse effects tend to less likely happen with increasing orders as the fifth-order, the seventh order and so on. Accordingly, by eliminating the third-order harmonic of the square wave, it is possible to obtain a waveform that can be regarded approximately as a sinusoidal wave.

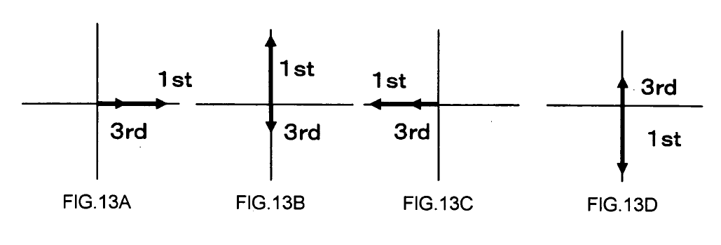

FIGS. 13A, 13B, 13C, and 13D show the phasor diagrams of the square wave I+, the square wave Q+, the square wave I−, and the square wave Q−, which are delivered from the square wave output circuit 1012, respectively. A phase shift of 90 degrees between the four square waves would also cause a phase shift of 90 degrees between their respective first-order (1st) components. On the other hand, the third-order (3rd) harmonic has the amount of phase rotation three times larger than that of the first-order component, and will thus be shifted by 270 degrees (−90 degrees) with respect to each other. That is, the phase relationship of the third-order harmonics between the four square waves I+, I−, Q+, and Q− is opposite to that of the first-order components.

As described above, in the polyphase filter 1014, the square wave I+ is supplied to the input terminal of the first path, the square wave Q+ to the input terminal of the second path, the square wave I− to the input terminal of the third path, and the square wave Q− to the input terminal of the fourth path. This allows the first-order component of the square wave to be filtered with the positive frequency characteristic, whereas the third-order harmonic is filtered with the negative frequency characteristic. Accordingly, the first-order component of the square wave remains unchanged to pass through the polyphase filter 1014 for output. On the other hand, since the polyphase filter 1014 has the extreme point Fd of its frequency characteristic having been adjusted to be at three times the frequency F1 of the square wave delivered from the square wave output circuit 1012, the third-order harmonic of the square wave is eliminated or attenuated by the polyphase filter 1014. That is, the polyphase filter 1014 makes it possible to obtain a sinusoidal wave with the third-order harmonic having been eliminated from a square wave.

The high-order bandpass filter and the LC resonator require a steep frequency selectivity between the first-order component and the third-order harmonic component, and thus needs a steep frequency characteristic, in the case of which multiple stages of filters have to be provided. Use of the polyphase filter will eliminate the need for a steep frequency selectivity between the first-order component and the third-order harmonic component of a square wave. That is, in the negative frequency region shown in FIG. 12, no steep frequency characteristic is required. As described above, this is because the first-order component and the third-order harmonic of a square wave operate separately in the “positive” and “negative” regions, respectively, so that even when the polyphase filter has no steep frequency characteristic, the first-order component will pass through the polyphase filter generally unchanged and only the third-order harmonic will be eliminated or attenuated. Accordingly, this will not require multi-stage polyphase filters but can be realized with a circuit reduced in size.

Furthermore, the high-order bandpass filter and the LC resonator are a filter which allows the first-order component to pass therethrough and which is provided with a time constant corresponding to the first-order component. In contrast to this, the polyphase filter is a filter that eliminates or reduces the third-order harmonic and may be thus provided with a time constant corresponding to the third-order harmonic. A circuit provided with a time constant corresponding to a lower frequency requires a larger circuit layout area. This is the reason why the polyphase filter can reduce the required circuit layout area when compared with the high-order bandpass filter or the LC resonator.

In this manner, this embodiment allows a circuit formed of a PLL, a VCO, a frequency divider, and the like to easily produce a multi-phase square wave as well as allows the polyphase filter having a frequency characteristic whose extreme point is adjusted to be at three times the frequency of the resulting square wave to filter the square wave. This makes it possible to obtain a generally perfect sinusoidal wave with a smaller circuit layout area when compared with the case where the high-order bandpass filter or the LC resonator is employed.

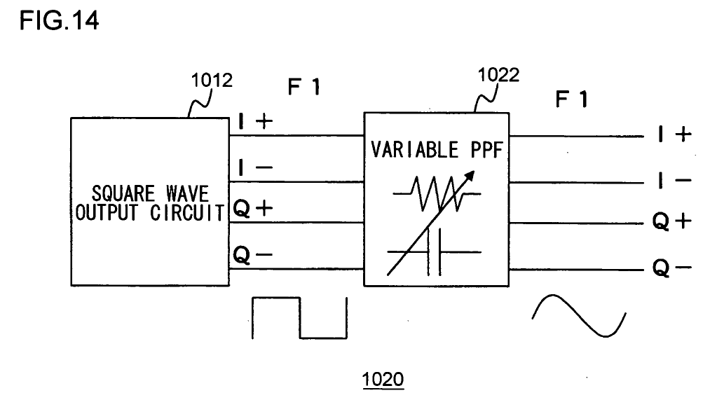

FIG. 14 is a view showing the configuration of a sinusoidal wave generation circuit 1020 according to a first modified example of the second embodiment of the present invention. The configuration of the sinusoidal wave generation circuit 1020 according to the first modified example of the second embodiment is basically the same as that of the second embodiment. The difference lies in that the polyphase filter 1014 according to the second embodiment is formed of variable elements.

That is, a polyphase filter 1022 according to the first modified example of the second embodiment of the present invention is composed of variable elements such as variable resistors and variable capacitors. More specifically, the resistors R2, R4, R6, and R8 and the capacitors C2, C4, C6, and C8 of the polyphase filter of FIG. 11 are replaced with variable resistors and variable capacitors, respectively, so that their resistance and capacitance can be controlled using an external signal.

As described above, the extreme point of the frequency characteristic of the polyphase filter is 1/(2πRC). Accordingly, the resistance R of the resistors R2, R4, R6, and R8 and the capacitance C of the capacitors C2, C4, C6, and C8 are controlled using an external signal, thereby making it possible to control the extreme point of the frequency characteristic of polyphase filter.

Thus, even in the presence of a change in the frequency of a square wave delivered from the square wave output circuit 1012, the sinusoidal wave generation circuit 1020 allows external control to be provided to the value of the variable elements of the polyphase filter 1022 in accordance with the frequency of the square wave. That is, it is possible to easily set the extreme point of the frequency characteristic of the polyphase filter 1022 to be at three times the frequency of the aforementioned square wave.

In this manner, the sinusoidal wave generation circuit 1020 according to the first modified example of the second embodiment of the present invention dynamically controls the frequency of a square wave delivered from the square wave output circuit 1012 and the extreme point of the frequency characteristic of the polyphase filter 1022, thereby allowing for making the frequency of the resulting sinusoidal wave changeable. Furthermore, the use of the polyphase filter allows its circuit layout area to be reduced.

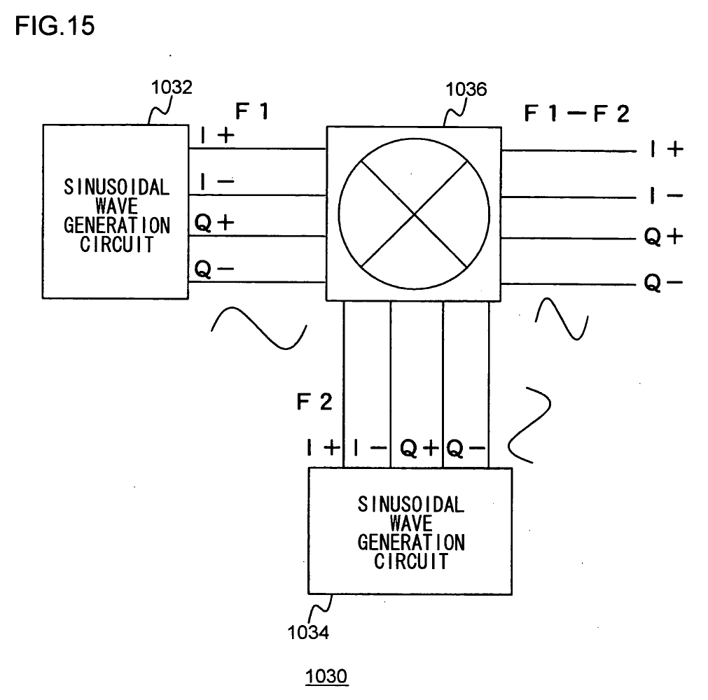

FIG. 15 is a view showing the configuration of a frequency conversion circuit 1030 according to a second modified example of the second embodiment of the present invention. The frequency conversion circuit 1030 includes two sinusoidal wave generation circuits 1032 and 1034, and a single side band (SSB) mixer 1036 (hereinafter referred to as a SSB mixer). As the sinusoidal wave generation circuits 1032 and 1034, it is possible to employ the sinusoidal wave generation circuit 1010 or 1020 according to the second embodiment or the first modified example thereof.

In the frequency conversion circuit 1030, the four sinusoidal waves I+, I−, Q+, and Q−, produced at the sinusoidal wave generation circuit 1032, which have a frequency F1 and are phase shifted by 90 degrees relative to each other are supplied to one of the input ports of the SSB mixer 1036. Furthermore, the other input port of the SSB mixer 1036 is supplied with the four sinusoidal waves I+, I−, Q+, and Q−, produced at the sinusoidal wave generation circuit 1034, which have a frequency F2 and are phase shifted by 90 degrees relative to each other. From the two sets of sinusoidal waves having respectively a frequency of F1 and F2, the SSB mixer 1036 produces four sinusoidal waves I+, I−, Q+, and Q− which have the frequency difference (F1−F2) therebetween and are phase shifted by 90 degrees relative to each other.

Since both the two sets of the sinusoidal waves with the harmonics included therein having been reduced are supplied to the SSB mixer 1036, it is possible to efficiently suppress unwanted spurious variations. Furthermore, the use of the polyphase filter allows its circuit layout area to be reduced.

In this manner, the frequency conversion circuit 1030 according to the second modified example of the second embodiment of the present invention makes it possible to satisfy the requirements for both improved characteristics and reduced circuit scales at the same time.

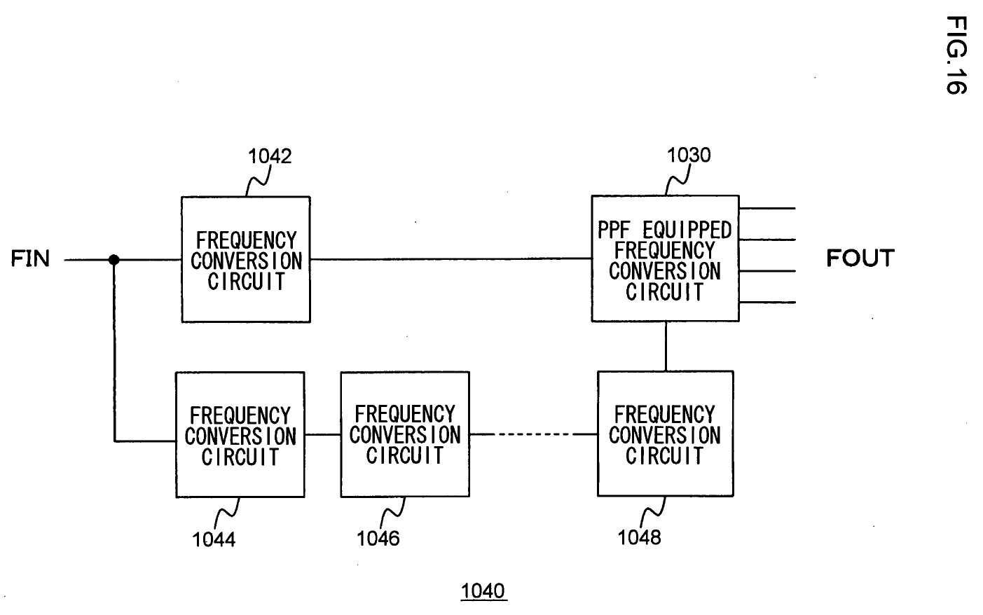

FIG. 16 is a view showing the configuration of a frequency synthesizer 1040 according to a third modified example of the second embodiment of the present invention. The frequency synthesizer of FIG. 16 includes a plurality of frequency conversion circuits. Of the frequency conversion circuits, a PPF equipped frequency conversion circuit 1030 which is provided at the output stage of the frequency synthesizer can be the frequency conversion circuit 1030 described in relation to the second modified example of the second embodiment of the present invention.

In FIG. 16, an externally supplied signal (at a frequency of FIN) is supplied to the frequency conversion circuits 1042 and 1044 for frequency conversion into respective desired frequencies. The frequency converted signal from the frequency conversion circuit 1042 is supplied to one input port of the PPF equipped frequency conversion circuit 1030. On the other hand, the frequency converted signal from the frequency conversion circuit 1044 is further subjected to a frequency conversion at frequency conversion circuits 1046 and 1048 and then supplied to the other input port of the PPF equipped frequency conversion circuit 1030. In accordance with the signals supplied from the frequency conversion circuits 1042 and 1048, the PPF equipped frequency conversion circuit 1030 performs a frequency conversion as described above to output a sinusoidal wave signal having a frequency of FOUT.

In the frequency synthesizer 1040 according to the third modified example of the second embodiment, one signal passes through a one-stage of a frequency conversion circuit and another signal passes through three-stages of frequency conversion circuits until the signals are supplied to the two input ports of the PPF equipped frequency conversion circuit 1030. However, the invention is not limited to this configuration but may also include any number of stages of frequency conversion circuits. It is also possible to directly supply an input signal to the PPF equipped frequency conversion circuit 1030 without passing through the frequency conversion circuits. Furthermore, a PPF equipped frequency conversion circuit may also be used for the frequency conversion circuit other than the one at the last stage.

As described above, since the frequency synthesizer 1040 according to the third modified example of the second embodiment employs the frequency conversion circuit 1030, described in relation to the second modified example, as the frequency conversion circuit located at the last stage, it is possible to obtain a sinusoidal wave having a desired frequency with unwanted spurious variations suppressed. Furthermore, the use of the polyphase filter allows its circuit layout area to be reduced. Accordingly, the frequency synthesizer 1040 according to the third modified example of the second embodiment makes it possible to satisfy the requirements for both improved characteristics and reduced circuit scales at the same time.

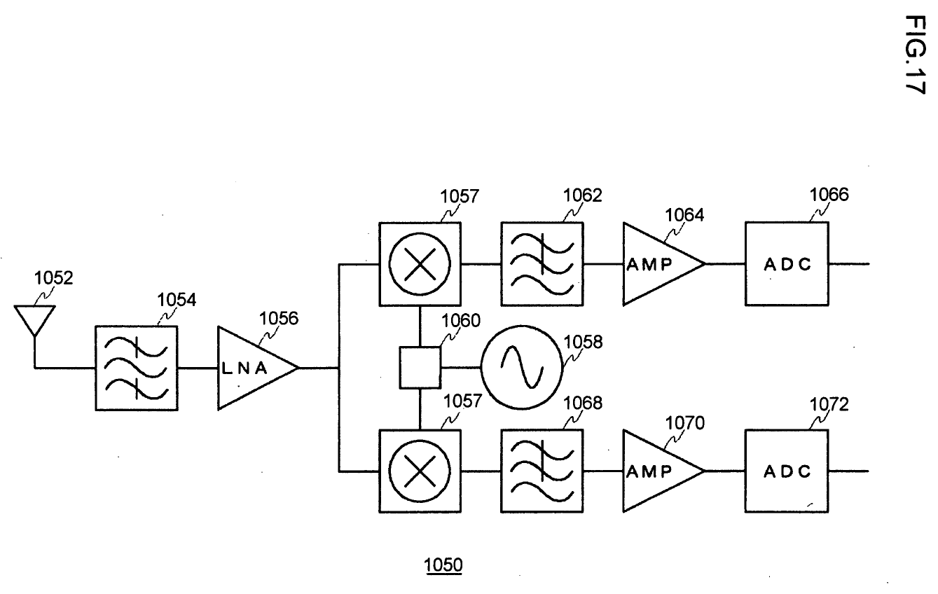

FIG. 17 is a view showing a communication system according to a fourth modified example of the second embodiment of the present invention. The communication system 1050 of FIG. 17 can employ, but is not limited to, the direct conversion receive (DCR) scheme, and as well other reception schemes such as the heterodyne reception scheme.

In FIG. 17, an RF signal received from an antenna 1052 is supplied to a LNA (Low Noise Amplifier) 1056 via a bandpass filter 1054. The LNA 1056 amplifies the RF signal with reduced noise and outputs the resulting signal to two frequency conversion circuits 1057 for use with the quadrature baseband signals or the I signal and Q signal.

A local oscillator 1058 outputs a local signal at a local (Lo) frequency. The frequency synthesizer 1040 described in relation to the third modified example of the second embodiment can be applied to this local oscillator 1058. A phasor 1060 outputs the Lo signal with its phase unchanged to the I-based frequency conversion circuit, while also delivering, to the Q-based frequency conversion circuit, the Lo signal having a phase leading by 90 degrees with respect to the Lo signal delivered to the I-based frequency conversion circuit. The signals delivered to these circuits have a square wave shape.

The I-based and the Q-based frequency conversion circuits 1057 mix the RF signal and the Lo signal, and then outputs a signal having a frequency difference therebetween to low pass filters 1062 and 1068, respectively. An output signal from each of the low pass filters 1062 and 1068 is amplified through respective amplifiers 1064 and 1070 and then converted into a digital signal by respective analog to digital converters 1066 and 1072.

In this manner, by the use of the local oscillator 1058 of this embodiment for the communication system 1050, it is possible to provide both improved characteristics and a reduction in circuit scale at the same time to communication systems. In particular, all or part of the circuit components described as the communication system 1050 can be incorporated into a semiconductor chip as a frequency synthesizer, thereby allowing the chip area to be reduced.

The present invention has been described in accordance with the embodiments. It is to be understood by those skilled in the art that while the embodiments are only illustrative, various modifications can be made to the combinations of each of the components and processes thereof and those modified examples also fall within the scope of the present invention.

For example, the first and second embodiments are designed to have a one-stage polyphase filter with an extreme point in its own frequency region associated with the third-order harmonic in order to reduce the third-order harmonic. In this regard, it is also acceptable to employ a total of two stages in order to reduce the third-order and fifth-order harmonics, wherein one stage of polyphase filter has the extreme point in its own frequency region associated with the third-order harmonic and the other stage of polyphase filter has the extreme point associated with the fifth-order harmonic. Additionally, in order to reduce frequency components subsequent to the seventh-order harmonic, it is also acceptable to employ three stages or more of polyphase filters, connected in cascade, with their extreme points in their own frequency regions associated with respective harmonics. This makes it possible to reduce spurious variations with further improved accuracy.

Furthermore, in accordance with the second embodiment, a polyphase filter including variable elements was described. The second embodiment is adapted to control both the resistor and capacitor as a variable element. However, only any one of them may be controlled as a variable element. In this regard, one or more of the plurality of polyphase filters forming the frequency conversion circuit may also be configured to include a variable element. This also allows for making the frequency of the resulting sinusoidal wave changeable.

Furthermore, as described above, the second embodiment is configured to provide the sinusoidal wave generation circuits 1032 and 1034 serving as a polyphase filter for both two input signals having different frequencies to the SSB mixer 1036. In this regard, it is also acceptable to provide only one of the polyphase filters. This also provides a certain level of reduction in spurious variation.

Additionally, a polyphase filter may also be provided on the output side of the SSB mixer 1036. In this case, it is possible to reduce spurious variations by associating an extreme point in the frequency region of the polyphase filter with the frequency region of the spurious variation to be reduced which occurs in the output signal from the SSB mixer 1036.

The present invention has been described in accordance with the specific embodiments. It should be understood that these embodiments have been shown by way of example only to illustrate the objects and applicable examples of the present invention. Accordingly, it is understood that while the invention is susceptible to various modifications and variations, the invention is to cover all modifications, equivalents, and alternatives falling within the spirit and scope of the invention as defined by the appended claims.

What is claimed is:

1. A frequency conversion method comprising:
pre-reducing a harmonic included in a square wave signal to be supplied to a single side band mixer; and
allowing the single side band mixer to mix a plurality of signals including a signal with the harmonic reduced.

2. A frequency conversion circuit comprising:
a single side band mixer; and
a polyphase filter connected at least to one of input and output ports of the single side band mixer, and wherein
the polyphase filter associates an extreme point in its own frequency region with a spurious variation to be reduced in the supplied square wave signal.

3. A frequency conversion circuit comprising:
a single side band mixer; and
a polyphase filter connected upstream of the single side band mixer, wherein
the polyphase filter associates an extreme point in its own frequency region with a spurious variation to be reduced in the supplied square wave signal.

4. The frequency conversion circuit according to claim 3, wherein
the polyphase filter associates the extreme point with the third-order harmonic included in the supplied square wave signal.

5. The frequency conversion circuit according to claim 2, wherein
at least one of the polyphase filters includes a variable element so that the extreme point can be controlled.

6. The frequency conversion circuit according to claim 2, wherein
the extreme point in the frequency region includes a dip frequency in a negative frequency region.

7. A communication system comprising:
an oscillator unit which oscillates a square wave local signal; and
a frequency conversion circuit which mixes the oscillated local signal and an externally received signal to produce a signal at a predetermined frequency.

8. A signal generation circuit comprising:
a square wave output circuit which outputs a square wave signal; and
one or more stages of polyphase filters which receive a signal delivered from the square wave output circuit and which associate an extreme point in an own frequency region with an Nth harmonic (wherein N is an odd number equal to three or more) included in the input signal.

9. The signal generation circuit according to claim 8, wherein
at least one of the one or more stages of polyphase filters associates an extreme point in the own frequency region with the third-order harmonic included in the input signal.

10. The signal generation circuit according to claim 8, wherein
at least one of the one or more stages of polyphase filters includes a variable element so as be able to control the extreme point.

11. A frequency conversion circuit comprising:
a mixer having input ports; and
a signal generation circuit according to claim 8 that is connected to at least one of the input ports of the mixer.

12. A frequency synthesizer including a plurality of frequency conversion circuits which are connected in parallel or cascade, wherein
at least a frequency conversion circuit located at the last stage out of the circuits is a frequency conversion circuit according to claim 11.

13. A communication system comprising:
an oscillator unit which oscillates a local signal; and
a frequency conversion circuit which mixes the oscillated local signal and an externally received signal to produce a signal at a predetermined frequency, wherein
the oscillator unit is formed of a frequency synthesizer according to claim 12.
